(19) United States
(12) Patent Application Publication
(10) Pub. No.: US 2016/0339685 A1
(43) Pub. Date: Nov. 24, 2016

(54) PLATEMAKING DEVICE

(71) Applicant: RISO KAGAKU CORPORATION, Tokyo (JP)

(72) Inventors: Kenichi NAKAJIMA, Tsukuba-shi (JP); Naoyuki TANAKA, Tsukuba-shi (JP); Norimitsu GOTO, Tsukuba-shi (JP); Takashi KUROHA, Tsukuba-shi (JP)

(21) Appl. No.: 15/057,648

(22) Filed: Mar. 1, 2016

(30) Foreign Application Priority Data
May 22, 2015 (JP) 2015-104699

(51) Int. Cl. B41D 1/06

(52) U.S. Cl. CPC B41D 1/06; B41N 1/247

(57) ABSTRACT

A screen printing plate is arranged on the front of a back plate vertically placed on a base, positioned by the base and a positioning member, and fixed by a fixing member. A thermal head is moved in respective directions of X, Y, Z by respective moving parts MX, MY, MZ, and a desired image is made on a screen. Since the screen printing plate is perpendicular to a horizontal plane, dust and the like slips on a surface of the screen printing plate and moves outside a platemaking area even if they drop on the screen without adhering to the surface. The Z-axis direction moving part MZ is provided with a Z-direction energizing unit and if a position in a Z-direction of the thermal head is adjusted by the Z-axis direction moving part MZ, force with which the thermal head presses the screen printing plate can be finely adjusted.

### TECHNICAL FIELD

The present invention relates to a platemaking device provided with a screen printing plate as an object, especially relates to a platemaking device that implements high platemaking quality because dust and the like hardly adhere to a screen, platemaking failure hardly occurs, and fine adjustment of pressure applied to the screen by a thermal print head (TPH) as a platemaking unit is possible.

### BACKGROUND OF ART

In Japanese Unexamined Patent Application Publication No. Hei 6-270379, an invention of a platemaking device for screen printing is disclosed. A horizontal table for platemaking 2 is provided to an upper part of a housing 1 of the platemaking device. A thermal head moving mechanism 4 for moving the thermal head 3 is arranged on the upside of the table 2 for platemaking. In platemaking, a screen printing plate acquired by attaching a screen 7 to a mounting frame 8 is horizontally laid on the table for platemaking 2 with the screen 7 on the upside, and a platen 9 is laid inside the mounting frame 8 with the platen closely in contact with the screen 7. The thermal head 3 is abutted on heat-sensitive material 14 of the screen 7, energization control over each heater element of the thermal head 3 is made according to a character and image data while the thermal head 3 is moved by the moving mechanism 4, and a platemaking image is formed by boring the heat-sensitive material 14 by the heat of the thermal elements.

### SUMMARY OF INVENTION

### Technical Problem

According to the platemaking device disclosed in Japanese Unexamined Patent Application Publication No. Hei 6-270379, since the screen printing plate is horizontally laid on the table for platemaking and a surface of the screen printing plate to which the heat-sensitive material is provided is exposed on the upside, a foreign matter such as dust drops on the surface of the screen printing plate and easily adheres to the surface, this inhibits the contact of the thermal print head and the heat-sensitive material in platemaking, and platemaking failure sometimes occurs.

To avoid such inconvenience, cleaning work such as brushing is normally performed immediately before platemaking is started and dust that drops on the surface of the screen printing plate is removed. However, static electricity is caused by brushing and further, additional dust is sometimes adsorbed.

Further, according to the platemaking device disclosed in Japanese Unexamined Patent Application Publication No. Hei 6-270379, since pressure required for platemaking is acquired by pressing the screen by the weight of a moving part including the thermal head and its support members, it is impossible to set the pressure to be equal to or below the weight of the moving part and to make adjustment for fine increase/decrease. To enable such fine adjustment of pressure, an adjustment mechanism that can reduce the weight of the moving part to an arbitrary extent is required to be separately provided, posing the problem that the structure becomes intricate and the manufacturing cost of the device increases.

The present invention is made in view of such related art and its problem, and its object is to provide a platemaking device where dust that drops on a surface of a screen printing plate is prevented from adhering to a screen, the occurrence of platemaking failure can be reduced as much as possible, pressure on the screen by a thermal head can be made lighter than the weight of the thermal head and the like without being influenced by the weight of the thermal head and its support members, and the pressure on the screen by the thermal head can be finely adjusted.

### Solution to Problem

The platemaking device according to a first aspect of the present invention is based upon a platemaking device that makes up, with a thermal head, a screen of a screen printing plate acquired by pasting the screen configured by gauze and a heat-sensitive film on a frame, including a holder that holds the screen printing plate to keep the screen inclined.

The platemaking device according to a second aspect of the present invention is based upon the platemaking device according to claim 1, including a moving mechanism that moves the thermal head along a surface of the screen of the screen printing plate held on the holder, and a pressing mechanism that presses the surface of the screen by the thermal head.

A platemaking device according to a third aspect of the present invention is based upon the platemaking device according to the second aspect, and has a characteristic that the moving mechanism is provided with a first movement unit that respectively moves the thermal head in two directions mutually orthogonal in a plane parallel to the surface of the screen of the screen printing plate held on the holder, and the pressing mechanism is provided with a second movement unit that moves the thermal head in a direction perpendicular to the surface of the screen and an energizing unit that brings the thermal head into contact with the surface of the screen at predetermined force when the second movement unit abuts the thermal head on the surface of the screen.

The platemaking device according to a fourth aspect of the present invention is based upon the platemaking device according to any of the first to third aspects and has a characteristic that a cover protruded in front of the surface of the screen is situated over the screen printing plate held on the holder.

### Advantageous Effects of Invention

According to the platemaking device disclosed in the first aspect of the present invention, when the screen printing plate is held on the holder, the screen printing plate is turned inclined from a horizontal plane. Therefore, firstly, since dust and the like slip on the surface of the inclined screen printing plate and move outside a platemaking area even if the dust and the like drop on the screen of the screen printing plate, it is unlikely that the dust and the like adhere to the platemaking area of the screen. Accordingly, in platemaking, since the thermal head can more likely abut on the screen in a normal state without the intervention of the dust and the like, the quality of platemaking is less likely deteriorated because of the dust and the like. Secondly, the device does not require large installation area, compared with a conventional type of device in which the screen printing plate is installed in parallel with a horizontal plane. Further, since the installation area is small as described above and a projected area onto the horizontal plane is small, a foreign matter and others hardly intrude into the device during work and even if they should intrude, the removal and cleaning are easy. Thirdly, since an operator that works in the vicinity of the device can easily view the whole surface of the screen printing plate, compared with the conventional type of device, the workability is satisfactory, and especially, since a perspective of the depth side of the platemaking area when the platemaking area is viewed from the worker is satisfactory, an operation error hardly occurs. Fourthly, since the positioning in a planar direction on the holder of the screen printing plate installed in a state in which the screen printing plate is inclined on the holder is made by self-weight, the screen printing plate can be automatically and precisely positioned in a required position on the holder and an installation error hardly occurs.

According to the platemaking device disclosed in the second aspect of the present invention, the thermal head can be moved by the moving mechanism while the thermal head is in touch with the surface of the screen of the screen printing plate held in the inclined state on the holder in platemaking. At that time, pressure at which the thermal head presses the surface of the screen can be adjusted by the pressing mechanism. Therefore, the pressure on the inclined screen of the thermal head can be finely controlled in accordance with various conditions and the quality of platemaking can be enhanced.

According to the platemaking device disclosed in the third aspect of the present invention, the thermal head can be moved in the two directions mutually orthogonal in the plane parallel to the surface of the screen by the first movement unit while the thermal head is in touch with the surface of the inclined screen in platemaking. At that time, pressure at which the thermal head presses the surface of the screen is determined by energizing force of the energizing unit that energizes the thermal head toward the surface of the screen by setting the position of the thermal head in the direction perpendicular to the surface of the screen by the second movement unit. The fine control of the pressure on the inclined screen of the thermal head can be securely made by changing the position of the thermal head in the direction perpendicular to the surface of the screen by the second movement unit and the quality of platemaking can be further enhanced.

According to the platemaking device disclosed in the fourth aspect of the present invention, since the cover protruded in front of the surface of the screen is situated over the screen printing plate held on the holder, dust and the like hardly drop on the surface of the screen, and it is more unlikely that the dust and the like adhere to the platemaking area of the screen.

### BRIEF DESCRIPTION OF DRAWINGS

FIG. 1A is a front view showing a screen printing plate which is an object of platemaking by a platemaking device in a first embodiment;

FIG. 1B is a right side view showing the screen printing plate which is the object of platemaking by the platemaking device in the first embodiment;

FIG. 2 is a sectional view viewed along a line S1-S1 in FIG. 1A;

FIG. 3 is a front view showing the platemaking device in the first embodiment;

FIG. 4A is a right side view showing the platemaking device in the first embodiment and FIG. 4B is a sectional view viewed along a line S2-S2 in FIG. 4A;

FIG. 5A is a plan view showing a state in which a thermal head of the platemaking device in the first embodiment is not in contact with a screen;

FIG. 5B is a right side view showing the state in which the thermal head of the platemaking device in the first embodiment is not in contact with the screen;

FIG. 6A is a plan view showing a state in which the thermal head of the platemaking device in the first embodiment is in contact with the screen;

FIG. 6B is a right side view showing the state in which the thermal head of the platemaking device in the first embodiment is in contact with the screen;

FIG. 7A is a plan view showing a state in which a thermal head of a platemaking device in a second embodiment is not in contact with a screen;

FIG. 7B is a right side view showing the state in which the thermal head of the platemaking device in the second embodiment is not in contact with the screen;

FIG. 8 is a plan view showing a state in which the thermal head of the platemaking device in the second embodiment is in contact with the screen;

FIG. 9 is a right side view showing a state in which a thermal head of a platemaking device in a third embodiment is not in contact with a screen;

FIG. 10A is a plan view showing a state in which the thermal head of the platemaking device in the third embodiment is in contact with the screen;

FIG. 10B is a right side view showing the state in which the thermal head of the platemaking device in the third embodiment is in contact with the screen;

FIG. 11 is a right side view showing a platemaking device in a fourth embodiment; and

FIG. 12 is a right side view showing a platemaking device in a fifth embodiment.

### DESCRIPTION OF EMBODIMENTS

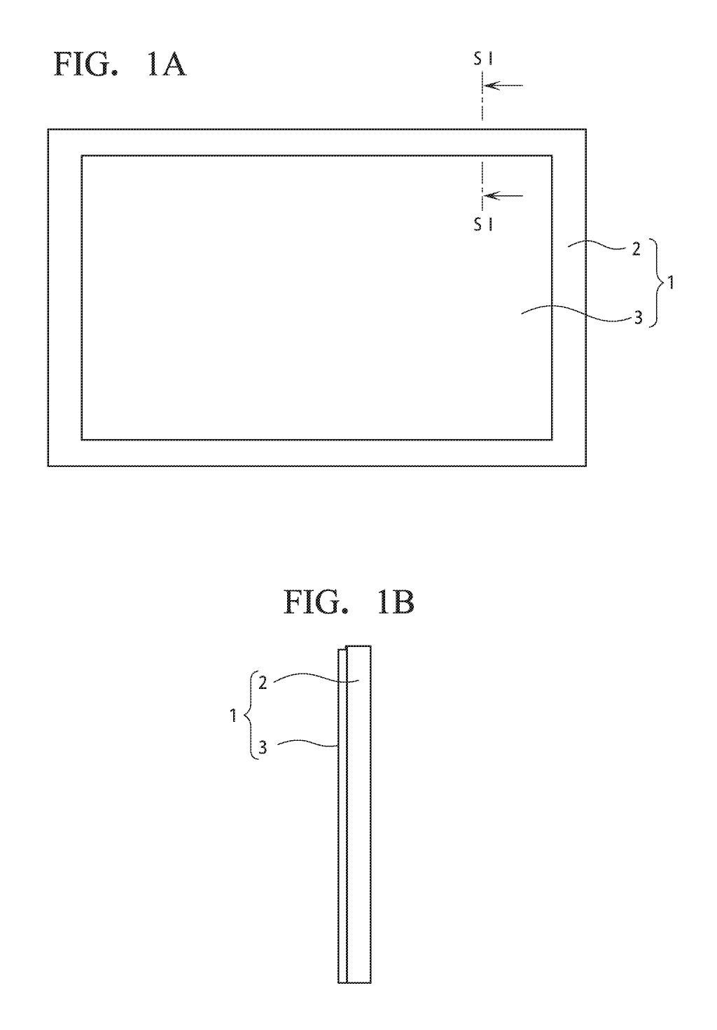

Referring to FIGS. 1 to 6B, a platemaking device equivalent to a first embodiment of the present invention will be described below.

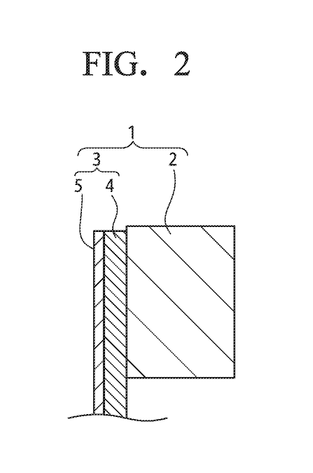

FIGS. 1A, 1B and 2 show a screen printing plate 1 which is an object of platemaking by the platemaking device in the first embodiment. The screen printing plate 1 is configured by a frame 2 acquired by combining bars the section of which is rectangular in the shape of a rectangle and a screen 3 pasted on one face of the frame 2 at predetermined tension without looseness. The screen 3 is a sheet in which gauze 4 acquired by knitting fiber such as polyester in a regular pattern and a heat-sensitive film 5 made of polyester and others are pasted, the side of the gauze 4 is pasted on one face of the frame 2, and the side of the heat-sensitive film 5 placed on the opposite side to the frame 2 is made up by the heat of a thermal head 27 to be described later.

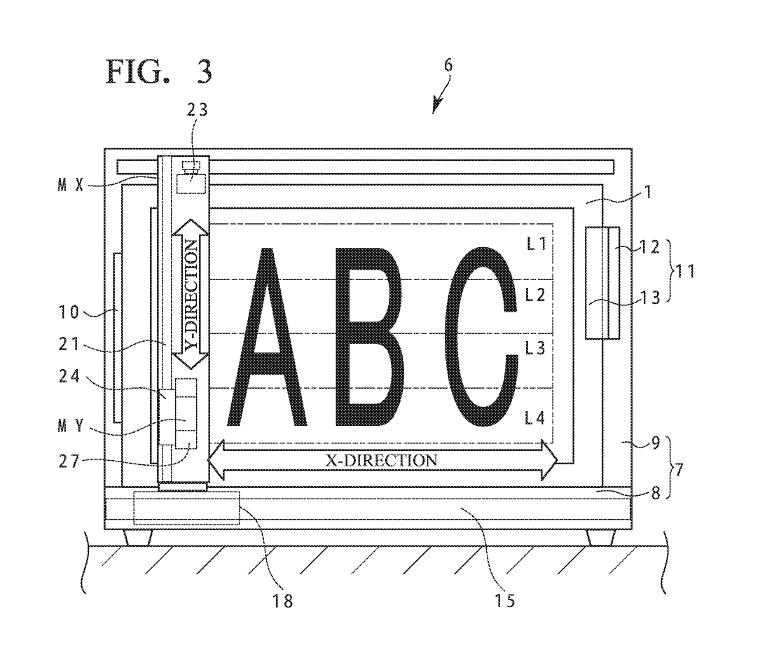

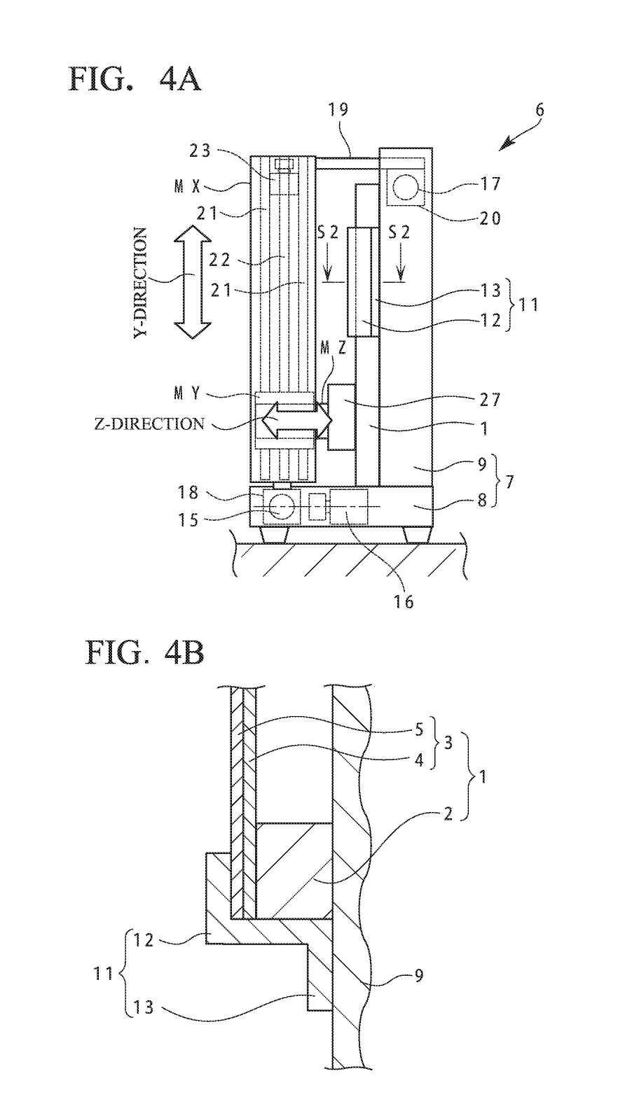

As shown in FIGS. 3 and 4A, the platemaking device 6 is provided with a holder 7 that holds the screen printing plate 1. The holder 7 is provided with a rectangular base 8 horizontally laid on a horizontal installation surface by legs provided at four corners of a bottom and a rectangular back plate 9 vertically planted along one long side on the inside of a top face of the base 8. A positioning piece 10 parallel to a vertical short side and perpendicular to the top face of the base 8 is attached on one side of the front of the back plate 9. To hold the screen printing plate 1 on the holder 7, an exposed other surface of the frame 2 of the screen printing plate 1 is abutted on a surface of the back plate 9, a bottom of the frame 2 is abutted on the top face of the base 8, and one side of the frame 2 is abutted on the positioning piece 10. A short side of the other side of the frame 2 is fixed to the back plate 9 by a fixing member 11.

As shown in FIG. 4B, the fixing member 11 is provided with a fitting part 12 abutted on the screen 3 which is the front of the screen printing plate 1 and the side of the frame 2 and a fixing part 13 overhanging outside a part in which the fitting part 12 is abutted on the side of the frame 2 and magnetically attached to the back plate 9. To fix the screen printing plate 1 in a predetermined position of the back plate 9 by the abovementioned fixing member 11, it is required that at least the fixing part 13 in the fixing member 11 is made of a magnet and a part on which the fixing part 13 is abutted of the back plate 9 is made of a magnetic substance.

As described above, the back of the screen printing plate 1 is abutted on the front of the holder 7 of the platemaking device 6, two sides of the frame 2 are butted against the positioning piece 10 and the top face of the base 8, and the frame is fixed by the other one side. As described above, since the positioning in a surface direction on the holder 7 of the screen printing plate 1 is made by self-weight, the positioning of required positions on the holder 7 can be automatically and precisely made and an installation error hardly occurs.

In this embodiment, the screen 3 which is a printing plate of the screen printing plate 1 is held to be an inclined state to a horizontal plane. In this case, the inclined state means that an angle with the horizontal plane exceeds 0 (zero) degree (not including 0 degree) and is an angle equal to or below 90 degrees (including 90 degrees). The inclination in this embodiment is 90 degrees. Except a case where the inclination is 90 degrees as in this embodiment, the screen 3 in the tilt range of the screen printing plate 1 according to the present invention is in a state in which the screen 3 having a planar projected area smaller than real area when the screen is viewed from an overhead direction is seen.

The reason why the screen printing plate 1 is held in such an inclined state is, first of all, to prevent as much dust and the like as possible from dropping on the screen 3 of the screen printing plate 1 and from adhering in a platemaking area. In this embodiment, since the screen printing plate 1 is set in the platemaking device 6 in an inclined state, dust and the like slip on the surface and go out of the platemaking area of the screen 3 even if the dust and the like drop on the screen 3, and it is unlikely that the dust and the like adhere in the platemaking area of the screen 3 and are left. Especially, since dust never adheres to the screen 3 because of static electricity and readily drops because of its weight, the dust is easily removed by the inclination of the screen 3. Accordingly, in platemaking, dust and the like hardly exist between the thermal head 27 to be described later and the screen 3 and the quality of platemaking is less likely deteriorated because of dust and the like.

For another effect by holding the screen printing plate 1 in the inclined state, secondly, area projected in the horizontal plane is small and area in which the device is installed may be small, compared with a conventional type device in which a screen printing plate 1 is installed in parallel with the horizontal plane. Further, therefore, a foreign matter and others hardly drop and are hardly mixed in the device during work and others and even if they are mixed, the removal and cleaning are easy.

Thirdly, since a workman who works in the vicinity of the device can readily view the whole surface of the screen printing plate 1, compared with the conventional type device, workability is satisfactory, and especially since a perspective on the inside of the platemaking area when it is viewed from the workman is satisfactory, an operation error hardly occurs. This is a remarkable effect when an especially large-sized screen printing plate is installed for platemaking.

As described above, from a viewpoint of acquiring the effect by inclination such as dust and the like hardly adhere to the screen 3, it is the most desirable that optimum values of inclination are 80 to 85 degrees. However, in the abovementioned first embodiment, the inclination is set to 90 degrees as described above also including a viewpoint that the design and manufacture of the device are easy and a manufacturing cost is reduced. Practically sufficient workability can be acquired at this inclination.

As shown in FIGS. 3 and 4A, a rectangular coordinate system of XYZ is supposed for the platemaking device 6 and the screen printing plate 1 installed in the platemaking device 6 as a criterion for providing a direction of platemaking operation by the thermal head 27 to be described later. That is, on the surface of the back plate 9 and in a plane of the screen 3 which is a printing plate of the screen printing plate 1, a horizontal lateral direction is an X-axis direction; on the surface of the back plate 9 and in the plane of the screen 3 which is the printing plate of the screen printing plate 1, a vertical longitudinal direction perpendicular to the direction of the X-axis is a Y-axis direction; and a direction perpendicular to the surface of the back plate 9 and the plane of the screen 3 which is the printing plate of the screen printing plate 1 is a Z-axis direction.

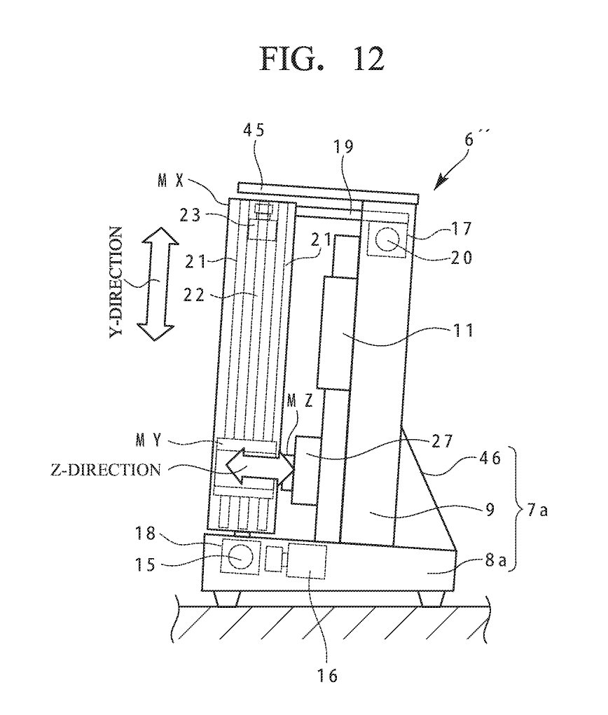

In this embodiment, as the back plate 9 of the holder 7 is perpendicular to the horizontal plane, the definition of each axis is as described above. However, when the back plate 9 of the holder 7 is inclined at an angle except a right angle with the horizontal plane (in a case shown in FIG. 12 in a fifth embodiment to be described later), the X-axis direction is the same while the Y-axis direction is a direction perpendicular to the X-axis direction on the surface of the back plate 9 and in the plane of the printing plate of the screen printing plate 1, and the Z-axis direction is a direction perpendicular to the surface of the back plate 9 and the printing plate of the screen printing plate 1.

As shown in FIGS. 3 and 4, the platemaking device 6 is provided with a first movement unit as a moving mechanism that moves the thermal head 27 along the surface of the screen printing plate 1 on the holder 7. The first movement unit is configured by an X-axis direction moving part MX that moves the thermal head 27 in the X-axis direction in a plane parallel to the surface of the screen printing plate 1 on the holder 7 and a Y-axis direction moving part MY that moves the thermal head in the Y-axis direction.

As shown in FIGS. 3 and 4A, the X-axis direction moving part MX is a vertically long member parallel to the Y-axis direction and can be arbitrarily reciprocated in the X-axis direction. A mechanism for arbitrarily reciprocating the X-axis direction moving part MX in the X-axis direction will be described below.

An X-axis direction driving shaft 15 is provided in parallel with the X-axis direction inside a front end of the base 8, and the X-axis direction driving shaft 15 can be driven by rotation in a desired direction by an X-axis direction driving source 16 provided inside the base 8. Further, an X-axis direction guide shaft 17 is provided inside an upper end of the back plate 9 in parallel with the X-axis direction. A first nut 18 screwed to the X-axis direction driving shaft 15 is provided to a lower end of the X-axis direction moving part MX, a first slider 20 is provided to an upper end of the X-axis direction moving part MX via a connector 19 parallel to the Z-axis direction, the first slider 20 is slidably fitted to the X-axis direction guide shaft 17, and the first slider can be moved in the X-axis direction. Accordingly, since the first nut 18 screwed to the X-axis direction driving shaft is moved along the X-axis direction driving shaft 15 when the X-axis direction driving source 16 is driven and the X-axis direction driving shaft 15 is turned, the upper end of the X-axis direction moving part MX is guided by the X-axis direction guide shaft 17 and can be moved in the X-axis direction.

As shown in FIGS. 3 and 4A, the Y-axis direction moving part MY is provided to the X-axis direction moving part MX and can be arbitrarily reciprocated in the Y-axis direction in the X-axis direction moving part MX. A mechanism for arbitrarily reciprocating the Y-axis direction moving part MY in the Y-axis direction will be described below.

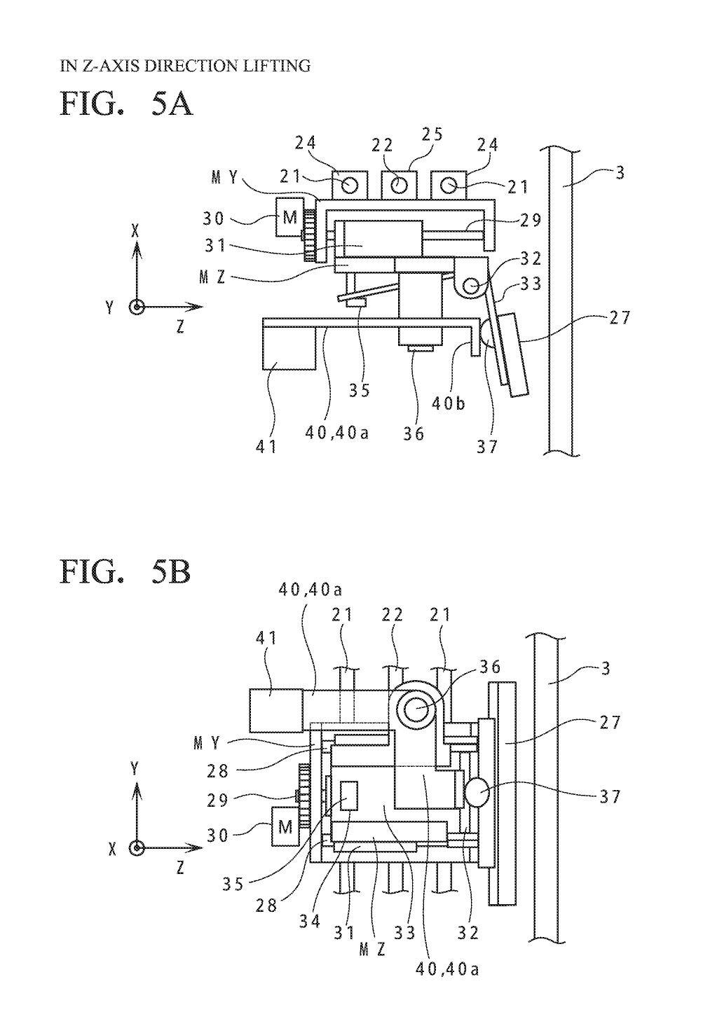

The X-axis direction moving part MX is provided with two Y-axis direction guide shafts 21 parallel to the Y-axis direction and one Y-axis direction driving shaft 22 provided between the two Y-axis direction guide shafts 21 in parallel with the Y-axis direction. The Y-axis direction driving shaft 22 can be driven by rotation in a desired direction by a Y-axis direction driving source 23 provided inside the X-axis direction moving part MX. The Y-axis direction moving part MY is provided with two second sliding parts 24 (see FIGS. 3 and 5A) slidably fitted to the two Y-axis direction guide shafts 21 and a second nut (see FIG. 5A) screwed to the Y-axis direction driving shaft 22. Accordingly, since the second nut 25 screwed to the Y-axis direction driving shaft is moved along the Y-axis direction driving shaft 22 when the Y-axis direction driving source 23 is driven to turn the Y-axis direction driving shaft 22, the Y-axis direction moving part MY is guided by the Y-axis direction guide shafts 21 and can be moved in the Y-axis direction.

As shown in FIGS. 4 and 5, the platemaking device 6 is provided with a second movement unit that arbitrarily reciprocates the thermal head 27 in a direction perpendicular to the surface of the screen 3 and an energizing unit that contacts the thermal head 27 with the surface of the screen 3 with predetermined force as a pressing mechanism in which the thermal head 27 presses the surface of the screen printing plate 1 on the holder 7.

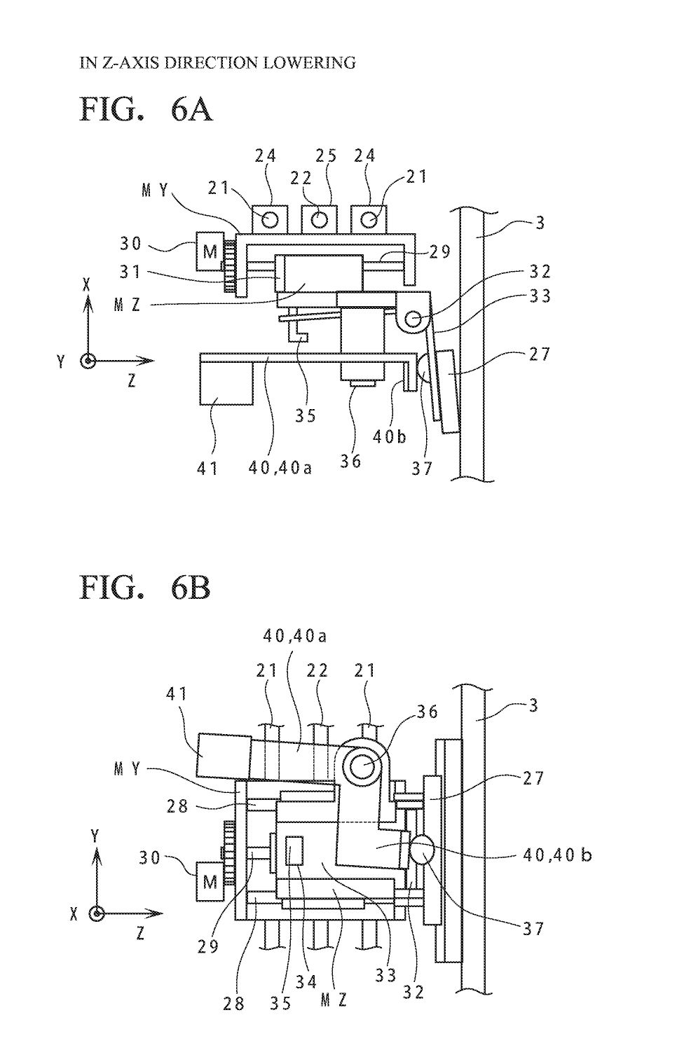

As shown in FIGS. 5 and 6, a Z-axis direction moving part MZ is provided to the Y-axis direction moving part MY as the second moving unit that arbitrarily reciprocates the thermal head 27 in the Z-axis direction.

As shown in FIGS. 5 and 6, the Z-axis direction moving part MZ can be reciprocated in a predetermined range in the Z-axis direction in a range of the Y-axis direction moving part MY. A mechanism for arbitrarily reciprocating the Z-axis direction moving part MZ in the Z-axis direction will be described below. The Y-axis direction moving part MY is provided with two Z-axis direction guide shafts 28 parallel to the Z-axis direction and one Z-axis direction driving shaft 29 provided between the two Z-axis direction guide shafts 28 in parallel with the Z-axis direction. The Z-axis direction driving shaft 29 can be driven by rotation in a desired direction by a Z-axis direction driving source 30 provided to the Y-axis direction moving part MY. The Z-axis direction moving part MZ is respectively slidably fitted to the two Z-axis direction guide shafts 28 and provided with a third nut 31 screwed to the Z-axis direction driving shaft 29. Accordingly, when the Z-axis direction driving source 30 is driven to turn the Z-axis direction driving shaft 29, the Z-axis direction moving part MZ is guided by the Z-axis direction guide shafts 28 because of the action of the third nut 31 screwed to the Z-axis direction driving shaft and can be moved in the Z-axis direction.

As shown in FIG. 5A and 6A, a support shaft 32 parallel to the Y-axis direction is provided on the side close to the screen printing plate 1 of the Z-axis direction moving part MZ and a support plate 33 having a shape which seems substantially L type in view parallel to the Y-axis is turnably journaled to the support shaft 32 at the corner. The thermal head 27 as a platemaking unit is attached to the side of an end of the support plate 33. Further, a hole 34 is provided to the side of a rear end of the support plate 33 and a fitting part 35 provided to the Z-axis direction moving part MZ is inserted into the hole 34. An end of the fitting part 35 is bent and prevents the support plate 33 from falling out of the fitting part 35. Accordingly, the support plate 33 to an end of which the thermal head 27 is attached can be turned with the support shaft 32 at the center in only a range where its rear end can be revolved between the Z-axis direction moving part MZ and a part for preventing falling out of the fitting part 35.

Though the details are not shown, the thermal head 27 is provided with multiple heater elements arranged in a predetermined platemaking width in the Y-axis direction at an edge on the far side from the support shaft 32. As shown in FIG. 6, when the support plate 33 is oscillated toward the screen printing plate 1 in a state in which the Z-axis direction moving party MZ is set in a predetermined position close to the screen printing plate 1 in the Z-axis direction, the heater elements located at the edge of the thermal head 27 are abutted on the screen 3. In this state, when the Z-axis direction moving part MZ is moved in the X-axis direction by the X-axis direction moving part MX while driving the heater elements according to platemaking information, a strip area parallel to the X-axis direction and having the predetermined platemaking width in the Y-axis direction can be continuously made up on a platemaking surface of the screen 3. Four strip lanes L1 to L4 partitioned in the platemaking width in the Y-axis direction are shown by imaginary lines (alternate long and short dash lines) on the screen 3 of the screen printing plate 1 shown in FIG. 3. However, each lane L is an area which can be made up by moving the thermal head 27 in the X-axis direction in each position in the Y-axis direction. In FIG. 3, three characters A, B, C are shown as an example of a prepress image.

As shown in FIGS. 5 and 6, for an energizing unit that abuts the thermal head 27 on the surface of the screen 3 with predetermined force, an arm plate 40 and weight 41 are provided to the Z-axis direction moving part MZ.

A turning shaft 36 parallel to the X-axis direction is provided to the Z-axis direction moving part MZ. The arm plate 40 having a shape which seems substantially L type in view parallel to the X-axis is attached to the turning shaft 36. The arm plate 40 is arranged in such an attitude that an L-type longer half 40a relatively long is located on the upside in the Y-axis direction of an L-type shorter half 40b relatively short and is turnably journaled by the turning shaft 36 at the corner. In this case, as shown in FIGS. 5A and 6A, since the turning shaft 36 to which the arm plate 40 is attached has a predetermined length in the Y-axis direction and the arm plate 40 is attached to its end, the turned arm plate 40 never interferes with the abovementioned turned support plate 33 except an end of the shorter half 40b.

Since the weight 41 is attached to an end of the longer half 40a of the arm plate 40, counterclockwise energizing force is constantly applied to the arm plate 40 in view parallel to the X-axis direction as shown in FIGS. 5A and 6A. Further, the end of the shorter half 40b of the arm plate 40 abuts on a hemispheric pressure part 37 located at the back on the end side of the turned support plate 33. Accordingly, the end of the shorter half 40b of the arm plate 40 constantly presses the pressure part 37 of the support plate 33 toward the screen printing plate 1 with a dead load of the weight 41 and thereby, the thermal head 27 is pressed in a direction of the screen 3.

Next, the action and the effect of the abovementioned platemaking device 6 in the first embodiment will be described.

As shown in FIGS. 3 and 4A, according to the platemaking device 6, when the screen printing plate 1 is installed on the holder 7, a dead load of the screen printing plate 1 is supported by the holder 7, and the screen printing plate 1 is supported by the back plate 9 and the positioning piece 10. The screen printing plate 1 is fixed to the back plate 9 by the fixing member 11. Therefore, the screen printing plate 1 can be precisely positioned.

The screen printing plate 1 installed on the holder 7 is positioned in a state perpendicular to the horizontal plane. Therefore, as dust and the like slip on the surface of the screen 3 and drop outside the platemaking area even if the dust and the like drop on the screen 3 of the screen printing plate 1, it is unlikely that the dust and the like adhere to the platemaking area of the screen 3. Accordingly, in platemaking, the thermal head 27 can abut on the screen 3 in a normal state without the effect of dust and the like and the quality of platemaking is never deteriorated because of dust and the like.

In platemaking, desired platemaking can be applied to the platemaking area of the screen 3 by abutting the thermal head 27 on the screen 3 at appropriate pressure, suitably controlling the X-axis direction moving part MX and the Y-axis direction moving part MY while driving the thermal head 27 by a platemaking signal and moving the thermal head 27.

Pressure at which the thermal head 27 presses the screen 3 in platemaking can be adjusted by adjusting a position in the Z-axis direction of the Z-axis direction moving part MZ.

As shown in FIG. 5, when the Z-axis direction moving part MZ is located in a position relatively sufficiently apart from the screen 3, the arm plate 40 is turned toward the screen printing plate 1 by the weight of the weight 41 and the end of the shorter half 40b presses the pressure part 37 of the support plate 33. The pressed support plate 33 and the thermal head 27 are set in the most protruded positions toward the screen 3. Since the support plate 33 is caught by the part for preventing falling out of the fitting part 35 in the Z-axis direction moving part MZ, the support plate is not turned any more toward the screen printing plate 1 and the thermal head 27 is stopped in this position.

The Z-axis direction moving part MZ is brought close to the screen 3 from a position shown in FIGS. 5A and 5B and the thermal head 27 is abutted on the screen 3 as shown in FIGS. 6A and 6B. When the Z-axis direction moving part MZ is brought closer to the screen 3 and the quantity in which the thermal head 27 pushes the screen 3 increases, clockwise rotation is applied to the arm plate 40 in a Y-Z plane as shown in FIG. 6B, and the weight 41 is lifted higher. As a result, pressure which the thermal head 27 applies to the screen 3 also increases.

According to the first embodiment, since the screen printing plate 1 is vertically installed, no dead load of the screen 3 is applied to the screen 3 in a direction perpendicular to the surface and accordingly, the screen 3 is not deflected by the dead load. In platemaking, pressure at which the thermal head 27 presses the surface of the screen 3 is determined by energizing force by the weight 41 of the arm plate 40 pushed back by reaction force from the screen 3. Accordingly, if the quantity in which the thermal head 27 pushes the screen 3 is adjusted by adjusting a position of the thermal head 27 in the direction perpendicular to the surface of the screen 3 in the Z-axis direction moving part MZ, a position of the weight 41 is adjusted, the fine adjustment of the pressure of the thermal head 27 on the screen 3 can be made securely, and the quality of platemaking can be enhanced.

The quantity (length) in which the thermal head 27 is moved in the Z-axis direction so as to adjust the pressure of the thermal head 27 on the screen 3 depends upon the size of the screen printing plate 1, the tension of the screen 3 and other various conditions. Generally, however, the quantity (the length) is approximately 10 mm. When the one platemaking device 6 in this embodiment should correspond to plural types of screen printing plates 1 different in various conditions, energizing force (the weight of the weight 41 in this embodiment) is changed by changing the energizing unit (the weight 41 in this embodiment) to another unit and an adjusted range of the pressure of the thermal head 27 on the screen 3 may also be changed.

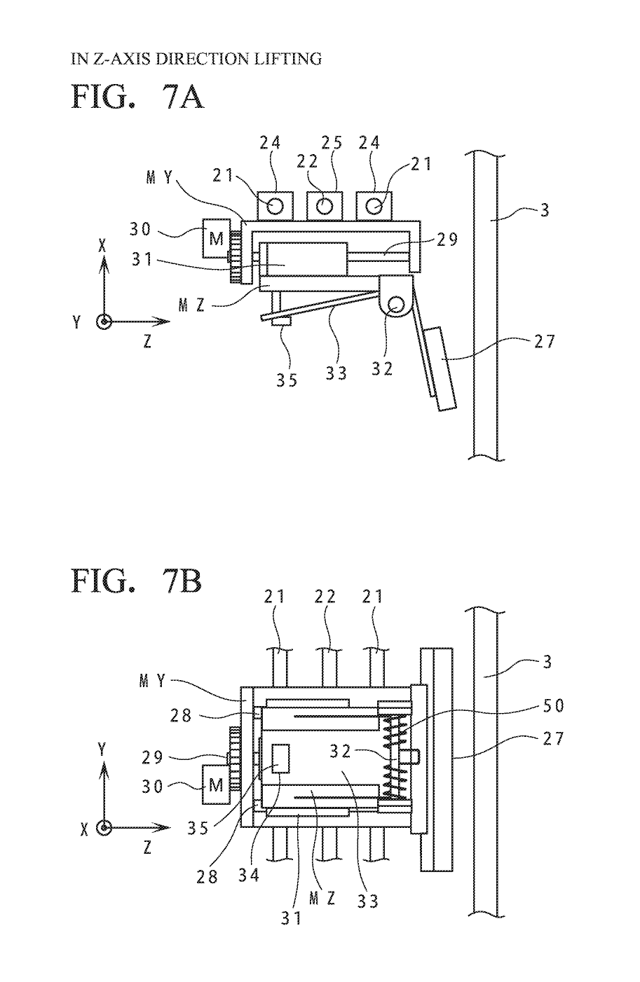

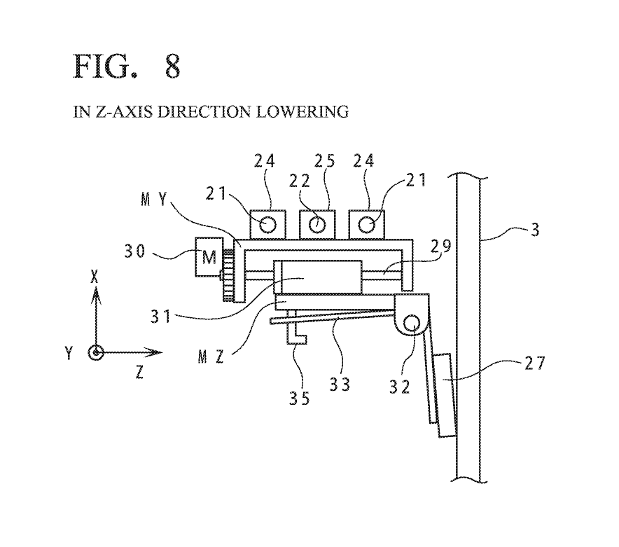

Next, a platemaking device equivalent to a second embodiment of the present invention will be described, referring to FIGS. 7A to 8. The second embodiment is different from the first embodiment in a pressing mechanism in which a thermal head 27 presses a surface of a screen 3. A different configuration and action will be mainly described below and the description of the rest that is the same as the description of the first embodiment is omitted.

As shown in FIGS. 7 and 8, in a Z-axis direction moving part MZ, an L-type support plate 33 to which the thermal head 27 is provided is turnably journaled with a support shaft 32 in the center as in the first embodiment. As shown in FIG. 7B, a helical torsion spring 50 as an energizing unit is wound onto the support shaft 32 of the support plate 33 and presses the support plate 33 and the thermal head 27 toward a screen printing plate 1.

As shown in FIG. 7, when the thermal head 27 is separated from the screen 3, the support plate 33 and the thermal head 27 are pressed by the helical torsion spring 50 and the support plate 33 is stopped in a position in which the support plate 33 is fitted to a part for preventing falling out of a fitting part 35. However, as shown in FIG. 8, when the thermal head 27 is abutted on the screen 3, pressure according to a variation of the helical torsion spring 50 determined by a position of the thermal head 27 for the screen 3 is applied to the screen 3. That is, pressure which the thermal head 27 applies to the screen 3 can be adjusted by changing the position of the thermal head 27 for the screen 3.

According to the second embodiment, in platemaking, pressure at which the thermal head 27 presses a surface of the screen 3 is determined by the variation of the helical torsion spring 50 determined by the position of the thermal head 27 for the screen 3. Accordingly, the fine adjustment of the pressure of the thermal head 27 for the screen 3 can be made securely by adjusting the position of the thermal head 27 in a direction perpendicular to the surface of the screen 3 in the Z-axis direction moving part MZ if the quantity in which the thermal head 27 pushes the screen 3 is adjusted, and the quality of platemaking can be enhanced.

When the platemaking device in the second embodiment is to correspond to plural types of screen printing plates 1, energizing force (determined by a spring constant of the helical torsion spring 50 in this embodiment) is changed by changing an energizing unit (the helical torsion spring 50 in this embodiment) to another unit to change an adjusted range of the pressure of the thermal head 27 for the screen 3.

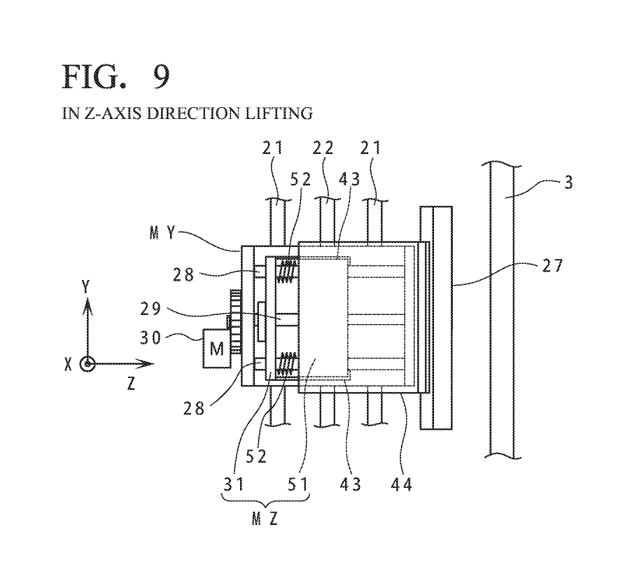

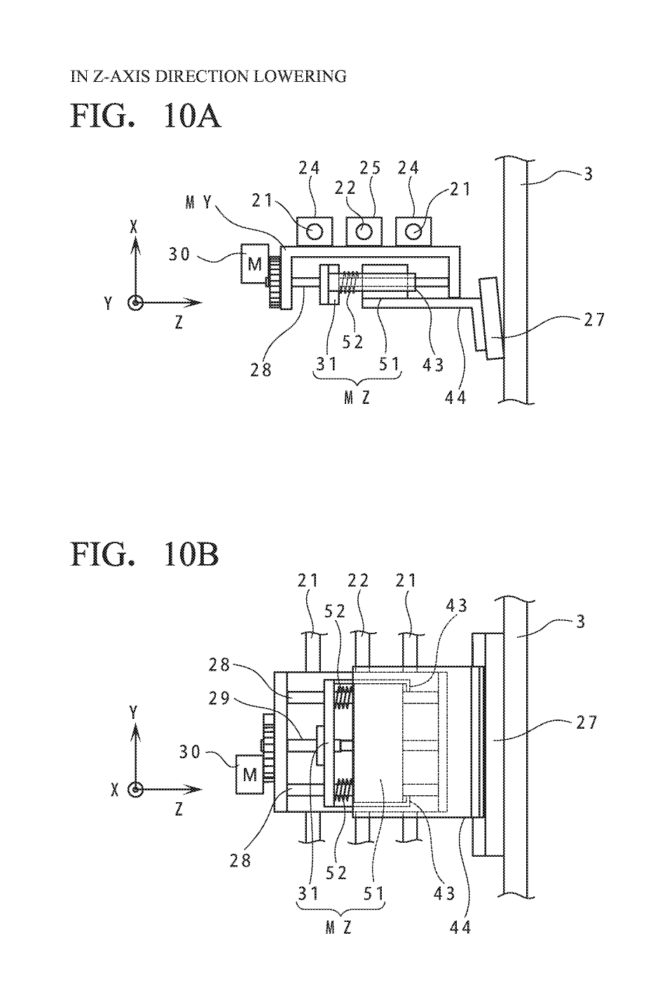

Next, a platemaking device equivalent to a third embodiment of the present invention will be described, referring to FIGS. 9 to 10B. The third embodiment is different from the first embodiment in a pressing mechanism in which a thermal head 27 presses a surface of a screen 3. A different configuration and action will be mainly described below and as the description of the rest that is the same as the description in the first embodiment is omitted.

As shown in FIGS. 9 to 10B, a Z-axis direction moving part MZ is provided with a third nut member 31 slidably fitted to a Z-axis direction guide shaft and screwed to a Z-axis direction driving shaft 29 and a block 51 separate from the third nut member 31 and fitted to the Z-axis direction guide shaft 28 and the Z-axis direction driving shaft 29. Further, a helical compression spring 52 as an energizing unit is wound on the Z-axis direction guide shaft 28 between the third nut member 31 and the block 51. Moreover, a fitting part 43 is provided to the sides of the block 51 of a top face and a bottom of the third nut member 31. The fitting part 43 is extended along a top face and a bottom of the block 51 and each end is bent on the side of the block 51. Accordingly, when the third nut member 31 is moved in a direction in which the third nut member approaches a screen printing plate 1, the third nut member 31 presses the block 51 via the helical compression spring 52 in the same direction, and when the third nut member 31 is moved in a direction in which the third nut member separates from the screen printing plate 1, the third nut member 31 makes the fitting part 43 fit to the block 51, pulls and moves the block 51 in the same direction. The thermal head 27 is attached to the block 51 via a support plate 44.

As shown in FIG. 9, when the Z-axis direction driving shaft 29 is turned and the third nut member 31 is moved in a direction in which it is separated from the screen printing plate 1, the block 51 pulled by the third nut member 31 and the thermal head 27 attached to the block are also moved in the direction in which they are separated from the screen 3 by the fitting part 43. As shown in FIG. 10, when the Z-axis direction driving shaft 29 is turned and the third nut member 31 is moved in a direction in which it approaches the screen printing plate 1, the thermal head 27 attached to the block 51 is also moved in the direction in which it approaches the screen 3 and is pressed on the screen 3. Hereby, the helical compression spring 52 is contracted and pressure according to its variation is applied to the screen 3. That is, pressure applied to the screen 3 by the thermal head 27 can be adjusted by changing a position of the thermal head 27 for the screen 3.

According to the third embodiment, in platemaking, pressure applied to a surface of the screen 3 by the thermal head 27 is determined by the variation of the helical compression spring 52 determined by the position of the thermal head 27 for the screen 3. Accordingly, if the quantity in which the thermal head 27 is pushed onto the screen 3 is adjusted by adjusting a position of the thermal head 27 in a direction perpendicular to the surface of the screen 3 in the Z-axis direction moving part MZ, the fine adjustment of pressure applied to the screen 3 by the thermal head 27 can be made securely and the quality of platemaking can be enhanced.

When the platemaking device in the third embodiment should correspond to plural types of screen printing plates 1, energizing force (determined by a spring constant of the helical compression spring 52 in this embodiment) is varied by changing an energizing unit (the helical compression spring 52 in this embodiment) to another unit and an adjusted range of the pressure of the thermal head 27 on the screen 3 may also be changed.

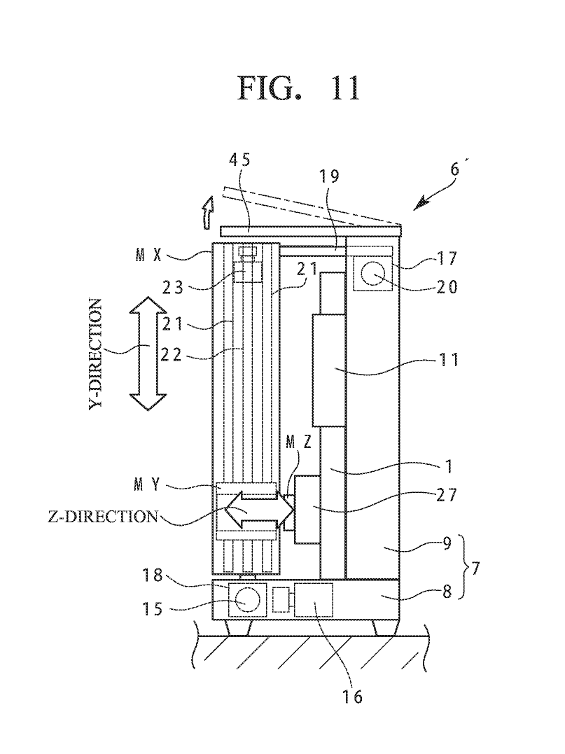

Next, a platemaking device 6′ equivalent to a fourth embodiment of the present invention will be described, referring to a right side view shown in FIG. 11.

As shown in FIG. 11, a cover 45 like eaves having a shape and area that cover the substantially whole surface in a plan view of a holder 7 is detachably attached to a top face of a back plate 9 in horizontal posture and covers a screen printing plate 1 held by the holder 7 from the upside. According to this platemaking device 6′, dust and the like hardly drop on a surface of a screen 3 and it is more unlikely than in the first to third embodiments that dust and the like adhere to a platemaking area of the screen 3. Further, even if the abovementioned cover 45 is provided, a platemaking surface of the screen printing plate 1 is never illegible for an operator and the cover does not hinder work.

The fourth embodiment is different from the first to third embodiments in only the cover 45. The rest of the configuration is the same and the description is omitted.

Next, a platemaking device 6″ equivalent to a fifth embodiment of the present invention will be described, referring to a right side view shown in FIG. 12.

As shown in FIG. 12, a base 8a of the platemaking device 6″ is the same as those in the first to fourth embodiments in that a top face is flat. However, the base is different from those in the first to fourth embodiments in that the dimension in the depth direction is larger and the base is tilted to be lower backward. A back plate 9 is vertically planted on the top face of the base 8a in parallel with one long side on the depth side slightly at the back of the center in the depth direction and a triangular support member 46 is provided between the back of the back plate 9 and the top face of the base 8a. An angle from a horizontal plane to the top face of the base 8a clockwise measured is approximately 5 degrees in FIG. 12 and accordingly, an angle from the horizontal plane to the surface of the back plate 9 counterclockwise measured is approximately 85 degrees in FIG. 12. According to the platemaking device 6, the fifth embodiment is substantially similar to the first to third embodiments in that dust and the like hardly drop on a surface of a screen 3 and it is unlikely that dust and the like adhere to a platemaking area of the screen 3. However, an operator that works in the vicinity of the device can readily view the whole surface of a screen printing plate 1, compared with the first to fourth embodiments, a perspective on the depth side of the platemaking area is satisfactory and an operation error hardly occurs. These effects are rather more significant than those in the first to fourth embodiments.

Further, according to this platemaking device 6″, since the upside of the back plate 9 is tilted backward, a Z-axis direction component of force of gravity applied to the screen printing plate 1 arranged on the surface of the back plate 9 is applied to the surface of the back plate 9 and action that positions the screen printing plate 1 in a Z-axis direction is also acquired. Furthermore, when the back plate 9 is turned by a slight angle with a virtual rotation axis provided to the substantial center of the surface and parallel to the Z-axis in the center with XY planes matched and a bottom of a frame 2 of the inclined screen printing plate 1 and one side are abutted and held on a positioning member and others on the holder side, positioning action in an X-axis direction and a Y-axis direction by self-weight is acquired.

The configuration of the back plate 9 itself and the other are the same as that in the fourth embodiment, and the description is omitted.

Furthermore, as shown in FIG. 12, in this embodiment, a cover 45 may also be provided to a top face of the back plate 9 as in the fourth embodiment. In an example shown in FIG. 12, the cover 45 is attached in parallel with the top face of the back plate 9. However, it is desirable that the cover 45 is arranged in parallel with the horizontal plane, the cover 45 is extended as the back plate 9 approaches the horizontal plane, and the front of the back plate 9 is covered with the cover 45. Hereby, since the whole surface of a printing plate of the screen printing plate 1 installed on the back plate 9 can be covered with the cover 45 in a vertical view when the tilt of the back plate 9 is at an angle close to the horizontal plane, the effect of preventing dust and the like from adhering can be acquired securely.

In each of the abovementioned embodiments, the device is configured so that the rectangular screen printing plate 1 can be installed in a laterally long state. However, the device may also be configured so that a rectangular screen printing plate 1 can be installed in a longitudinally long state. That is, the configuration of the base 8 and others may also be amended so that the platemaking device 6 shown in FIG. 3 can be installed on the installation surface in a state in which the platemaking device 6 is turned by 90 degrees counterclockwise with an axis perpendicular to page space in the center.

### DESCRIPTION OF REFERENCE NUMERALS

Description of reference numerals given in the figures is as follows.
1 . . . screen printing plate
2 . . . frame
3 . . . screen
4 . . . gauze
5 . . . heat-sensitive film
6, 6′, 6″. . . platemaking device
7, 7a . . . holder
27 . . . thermal head
40 . . . arm plate as energizing unit that configures pressing mechanism of thermal head
41 . . . weight as energizing unit that configures pressing mechanism of thermal head
45 . . . cover
50 . . . helical torsion spring as energizing unit that configures pressing mechanism of thermal head
52 . . . helical compression spring as energizing unit that configures pressing mechanism of thermal head
MX . . . X-axis direction moving part that configures first movement unit as moving mechanism of thermal head
MY . . . Y-axis direction moving part that configures first movement unit as moving mechanism of thermal head
MZ . . . Z-axis direction moving part as second movement unit that configures pressing mechanism of thermal head

1. A platemaking device that makes up, with a thermal head, a screen of a screen printing plate acquired by pasting the screen configured by gauze and a heat-sensitive film on a frame, comprising a holder that holds the screen printing plate to keep the screen inclined.

2. The platemaking device according to claim 1, comprising:
a moving mechanism that moves the thermal head along a surface of the screen of the screen printing plate held on the holder; and
a pressing mechanism that presses the surface of the screen by the thermal head.

3. The platemaking device according to claim 2,
wherein the moving mechanism is provided with a first movement unit that respectively moves the thermal head in two directions mutually orthogonal in a plane parallel to the surface of the screen of the screen printing plate held on the holder; and
the pressing mechanism is provided with a second movement unit that moves the thermal head in a direction perpendicular to the surface of the screen and an energizing unit that brings the thermal head into contact with the surface of the screen at predetermined force when the second movement unit abuts the thermal head on the surface of the screen.

4. The platemaking device according to claim 1, wherein a cover protruded in front of the surface of the screen is situated over the screen printing plate held on the holder.
